(19) United States
(12) Patent Application Publication
(10) Pub. No.: US 2010/0315220 A1
(43) Pub. Date: Dec. 16, 2010

(54) DIFFERENTIAL BRAKING ALERT SYSTEM AND METHOD

(76) Inventor: Tzahi DUANI, Bat Yam (IL)

Correspondence Address: LOWE HAUPTMAN HAM & BERNER, LLP, 1700 DIAGONAL ROAD, SUITE 300, ALEXANDRIA, VA, 22314, US

(21) Appl. No.: 12/814,694

(22) Filed: Jun. 14, 2010

Related U.S. Application Data
(63) Continuation-in-part of application No. PCT/IL2007/001540, filed on Dec. 12, 2007.

(51) Int. Cl. B60Q 1/00

(52) U.S. Cl. 340/453

(57) ABSTRACT

Signal lights are connected to the standard car braking alert circuit and to a first and second additional circuits respectively. A pole balanced on a pivot determines the flashing of different signals by activating switching means to close one or more circuits depending on the magnitude of the braking operation.

### RELATED APPLICATIONS

The present application is a continuation-in-part, and claims priority from, International Application Number PCT/IL2007/001540, filed Dec. 12, 2007, the disclosure of which is hereby incorporated by reference herein in its entirety.

### FIELD OF THE INVENTION

The invention is in the field of braking alert light systems for vehicles.

### BACKGROUND OF THE INVENTION

The importance of interaction between vehicles traveling along the same road has been known for a long time. Front and rear lights have been used to indicate a first vehicle's location to the driver of a second vehicle in the dark and under reduced light conditions.

Separate braking alert lights are used to indicate braking by a driver of a front car to the driver of a rear car, prompting the driver of the rear car to lower velocity so as to prevent collision.

In recent years it has become a widespread standard to install a braking light in the rear window of vehicles whereby drawing the rear driver's attention to the lights indicating the decelerating of a front car is facilitated and many a potential accident due to unnoticed braking of a front car is prevented.

However a mere indication that the front driver has stepped on the brake pedal is not sufficient to inform the rear driver whether the car in front of him is just slightly decelerating or the brake pedal has been forcefully pressed down for promptly stopping the car.

Obviously, distinction between slight braking, increased braking and harsh, emergency braking is of utmost importance as in the first case the rear driver only needs to adapt the speed of his car to the one before him, with quite a long time available for an easier response, in the second case response must be faster and in the third case the rear driver must respond immediately to avoid collision.

Public awareness of the need to avoid the risks to a rear car in the event of sudden braking of the car driving in front is steadily increasing and many drivers would be willing to install in their car a system for differential braking alert if such system were relatively easy to install and available at a reasonable price.

### SUMMARY OF THE INVENTION

The present invention relates to a system for providing different braking alert signals to a driver in a rear car, signals which indicate braking operations of different magnitude by a driver in a front vehicle having the system. The system comprises:
a. differential braking light array wherein a first number of braking alert lights is connected to a conventional car braking alert light circuit said first number of breaking alert lights is constituting slight breaking alert means, a second number of braking alert lights is connected to a first electric circuit and is constituting increased breaking alert means and a third number of braking alert lights is connected to a second electric circuit and is constituting emergency breaking alert means, both said first and second electric circuits are fed from the conventional car braking light circuit (their activation thereby depend on activation of the conventional car braking light circuit);
b. a pole having a balanced rest position (i.e. a position substantially taken by the pole when the vehicle is in rest) about a pivot in the vehicle and being pivotable from the balanced rest position in a vertical plane parallel to the driving direction of the vehicle, a weight of or connected to said pole below said pivot is balancing the pole towards the balanced rest position such that an actuating means connected to or being a portion of said pole follows a semicircular course when the pole is pivoting due to deceleration of the vehicle;
c. a stop means to limit the pivoting of said pole away from said balanced rest position when the vehicle is accelerating;
d. a first and a second switch generating means disposed along the semicircular course followed by the actuating means when the pole is pivoting away from said balanced rest position when the vehicle is decelerating, each of the said first and second switch generating means being adapted to operate a respective relay means to close and open the said first and second electric circuits respectively according to a deviation of the pole from the balanced rest position.

According to various embodiments of the invention the said array of braking alert lights is disposed in the lower frame of a rear window of said vehicle, the said first number of braking alert lights comprises one or more slight braking alert lights, the said second number of braking alert lights consist of two pairs of increased braking alert lights symmetrically disposed at each end of the said first number of braking alert lights and the said third number of braking alert lights consists of two pairs of emergency braking alert lights symmetrically disposed at the outer ends of each of the said pairs of increased braking alert lights.

The first number of braking alert lights, the second number of braking alert lights and the third number of braking alert lights may be configured to flash in different colours.

In a first embodiment the actuating means and the said switch generating means are made of electrically conductive material. In other embodiments the actuating means can be formed from any acceptable material which its semicircular movement with the pole is traceable by a sensor of the switch generating means. For example, the sensor may be a photoelectric cell capable of optically recognizing the amount of deviation of the actuating means from its rest position and converting the amount of deviation into an electrical signal which in turn cause a respective relay to turn on respective breaking alert lights.

In various embodiments of the invention the stop means is a mechanical obstacle inhibiting further deviation of the pole by blocking its way.

Alternatively the stop means may be a spring, or a string which restrict further motion of the pole when stretched to a predetermined maximum.

In various preferred embodiments of the invention the actuating means, the stop means and the switch generating means are located in the vehicle trunk.

The invention further relates to a method of providing different braking alert signals to a driver in a rear vehicle to indicate braking operations of different magnitude by a driver in a front vehicle (by a system according to any of the various embodiments described in this specification), the method comprises:

a. providing current from a conventional car braking alert system, to a first number of braking alert lights such that said first number of braking alert lights are flashed simultaneously with conventional car braking alert lights, when the brakes are pressed lightly;
b. recognizing deviation of said pole out of a balanced rest position such that the actuating means reaches the first switch generating means thereby causing the first switch generating means to operate a respective first relay whereby said first electric circuit is closed and said second number of braking alert lights are flashed when the brakes are pressed with increased pressure;
c. recognizing further deviation of said pole out of its balanced rest position such that the actuating means reaches the second switch generating means thereby causing the second switch generating means to operate a respective second relay whereby said second electric circuit is closed and said third number of braking alert lights are flashed whereby all of said braking alert lights are signaling at the same time when the brakes are pressed with extremely harsh force; and
d. stopping the current from the standard car alert system such that all the braking alert lights are extinguished when the braking operation is stopped.

The method preferably comprises a step of preventing deviation of the said pole from its balanced rest position by a stop means, a spring or a string, when the vehicle is accelerating.

Preferably, the first number of braking alert lights is a single light constituting slight braking alert indicating slight braking operation and is disposed at the center of the said array of braking alert lights.

In various preferred embodiments said array of braking alert lights is disposed in the lower frame of a rear window of said vehicle, the said first number of braking alert lights comprises one or more braking alert lights, the said second number of braking alert lights consist of two pairs of braking alert lights symmetrically disposed at each end of the said first number of braking alert lights and the said third number of braking alert lights consists of two pairs of braking alert lights symmetrically disposed at the outer ends of each of the said pairs of the second number of braking alert lights.

The actuating means and the said first and second switch generating means are made of electrically conductive material, and during an increased braking operation the actuating means reaches the said first switch generating means such that the said first electronic circuit is closed whereby the said second number of braking alert lights are flashed and during an emergency braking operation the actuating means reaches the second switch generating means such that the said second electric circuit is closed whereby the said third number of braking alert lights are flashed.

In various preferred embodiments the method comprises providing flashing lights of respective different colors for different braking signals.

### DETAILED DESCRIPTION OF THE INVENTION

The invention proposes a system and method for differential braking alert that indicates different types of braking operations executed by a driver of a car driving in front (hereinafter: front driver) to the driver of a car driving in the rear (hereinafter rear driver), enabling the rear driver to respond adequately to slow deceleration as a result of a slight braking operation by the front driver and to increased deceleration due to an increased braking operation as well as to extremely fast deceleration due to a sudden, forcible emergency braking operation. The inventive system is made of simple, low price components and it enables time and cost saving installation. Thus the novel differential braking alert system is adapted to widespread use. The inventive system and method enable automatic indication of different changes in the driving speed of a vehicle to drivers on the road behind it thereby furthering the all important objective of communication between vehicles that is of crucial importance in the prevention of road accidents.

In accordance with the invention a differential braking alert system for a vehicle is proposed. The differential braking alert system is additional to the plain conventional (hereinafter “standard”) vehicle braking alert light system that flashes the plain conventional (hereinafter “standard”) vehicle braking alert lights in every event of braking, of any magnitude. According to a preferred embodiment of the invention the differential braking alert system comprises an array of braking alert lights with a single slight braking alert light for indicating a slight braking action, a first pair of increased braking alert braking lights for indicating increased braking and a second pair of emergency braking alert lights for indicating sudden and forcible braking that will be designated herein below as emergency braking. The signal light that indicates slight braking action is directly fed from the standard braking alert light circuit of the car. The increased braking alert lights are connected to a first electrical circuit with a relay means and the emergency braking alert lights are connected to a second electrical circuit with a second relay means. In a preferred embodiment of the invention each of the first and second electrical circuits is fed by current from the standard vehicle braking alert system when closed by its respective relay means. It will be understood that due to this design of the electric circuits of the braking alert lights, the said braking alert lights of the differential braking alert system are subjected to the operation of the standard car braking alert system such that none of the lights of the differential braking alert system is flashed unless the standard vehicle braking alert system is activated.

It will be further understood that the braking alert light that indicates slight braking action may be installed as standard in the vehicle or it may be installed post manufacture as part of the differential braking alert system.

The array of braking alert lights is installed in a location on the rear side of the vehicle that is visible to the driver of a vehicle driving in the rear. In accordance with various preferred embodiments the inventive braking alert light array is disposed adjacently along the top or the bottom frame of the rear window of the vehicle.

The differential braking alert system further comprises a pivotable member, e.g. a pole, suspended on a pivot with a balancing weight provided at a lower end of the pivotable member and an actuating means provided at an end of the pivotable member. The pivotable member will be termed hereinafter “pole”, though it can be of any acceptable shape without departing from the scope of the present invention. The position of the pole when its center of gravity is in the lowermost position will be designated herein below as the resting position, or as the balanced rest position. The pole is free to turn around the pivot in a perpendicular plane that is parallel to the side walls of a regular vehicle, e.g. parallel to the straight traveling direction of the vehicle, and a stop means is provided to prevent a full rotation of the pole such that the actuating means is only allowed to move a small distance when the vehicle accelerates and it is free to move along a semicircular route when the vehicle decelerates.

A first and second electrical switch generating means are disposed along the semicircular route of the actuating means. During driving and in response to acceleration and deceleration of the vehicle the pole oscillates around its resting position due to the restoring force, as known in physics. When the vehicle is braked, the balancing weight means swings forward in the direction of driving due to inertia and the actuating means swings backwards, away from the direction of driving. The actuating means then advances along the said semicircular path and it may stop before reaching the first electrical switch generating means, or it may reach said first electrical switch generating means or it may reach the first electrical switch generating means and continue to advance until reaching the said second electrical switch generating means, depending on the magnitude of the force applied to the vehicle brake. In the event of slight braking, the weight is only slightly dislocated in the direction of driving and the upper end of the pole slightly swings back away from the direction of driving, then the pole gradually returns to its resting position. In this case only the slight braking alert light goes on, together with the standard car braking alert lights. During increased braking, the weight is dislocated towards the vehicle front in the direction of driving while the upper end of the pole swings backward against the direction of driving such that the actuating means advances to a position that is in close proximity to said first electrical switch generating means, the actuating means moves the electrical switch from off position to on position, the first relay means is activated by the said electrical switch whereby the first circuit is closed and a first number of auxiliary braking lights are switched on. In the event of extreme or emergency braking, the pole swings with considerably increased momentum such that the actuating means passes the position of the first electrical switch generating means, causing the first electrical switch generating means to pass from off position to on position, whereby the first relay means is activated and the said first circuit is closed and the said first number of auxiliary braking lights is switched on and then the actuating means continues on its path to reach the said second electrical switch generating means whereby the second electrical switch generating means is also made to pass from off position to on position, the second relay means is activated by the said second switch generating means and the said second circuit is also closed such that a second number of auxiliary braking lights are switched on in addition to the first auxiliary braking lights. When braking is stopped, supply from the electrical circuit of the standard car braking light stops and as a result, supply to the circuits operating the lights of the inventive system also stops. The lights go out immediately and the pole swings back to vertical position. The actuating means passes the semicircular path in the reverse direction, passing first the second switch generating means and then the first switch generating means, returning both electrical switch generating means to their original position, whereby the first and second electrical circuits are reopened by their respective relay means. It will be understood that depending on the force of the braking operation and on the design of the pole, the weight means, the actuating means and the switch generating means, the pole may swing farther away from its resting position such that the actuating means passes beyond the second switch generating means before it returns to the resting position. It will be understood that a spring means may be attached to the pole and connected to a suitable position in the vehicle to restrain the movement of the pole away from the resting position. Such spring may be calibrated to be adapted for different car designs.

It is an important advantage of the invention that it does not require installation of the inventive braking alert system during production. It is a further advantage of the invention that the inventive system may applied in different types of vehicles and installed in many different locations within the vehicle, including the baggage compartment. In accordance with yet another advantage of the invention, due to the simple parts that are comprised in the inventive system, the invention may be available at low cost and affordable to a great number of users. Such system may also become subject to regulations that would be easily enforceable. Insurance companies may reasonably require their clients to install the inventive system, whereby a considerable saving of expenses would be achieved.

In accordance with another aspect of the invention, the novel differential alert system is a system for providing different braking alert signals to a driver in the rear car to indicate braking operations of different magnitude by a driver in a front vehicle, comprising:

a. a differential braking light array wherein a first number of braking alert lights is connected to the standard car braking alert light circuit, a second number of braking alert lights are connected to a first electric circuit and a third number of braking alert lights are connected to a second electric circuit, both of said first and second electric circuits being fed from the standard car braking light circuit;
b. a pole balanced on a pivot at a suitable location in the vehicle in a perpendicular position, said pole being free to oscillate about the said pivot in a plane parallel to the longitudinal sides of the vehicle, said pole comprising an upper section above said pivot and a lower section below said pivot, a weight means on the end of said lower section and an actuating means on the end of said upper section such that when the pole oscillates away from said perpendicular position in a direction opposite to the direction of driving said actuating means follows a semicircular course;
c. a stop means to limit said oscillation of said pole away from said perpendicular position in the direction of driving;
d. and a first and a second switch generating means disposed along said semicircular course followed by the actuating means when the pole oscillates away from said perpendicular position in a direction opposite to the direction of driving, each of the said first and second switch generating means being adapted to operate a respective relay means to close and open the said first and second electric circuits respectively.

The inventive system is operated to create different signals indicating the intensity and magnitude of a braking operation in the vehicle in accordance with the following method:

(1) when the vehicle brakes are pressed lightly, current from the standard car braking alert system is fed to said first braking alert light and said first number of braking alert lights are flashed simultaneously with the standard car braking alert lights;
and
(2) when the vehicle brakes are pressed with increased pressure said pole swings out of its resting position in a direction that is opposite to the direction of driving; said actuating means reaches said first switch generating means; said actuating means switches said first switch generating means to on position whereby said first electric circuit is closed and said second number of braking alert lights are flashed;
and
(3) when the vehicle brakes are pressed with extremely harsh force said pole swings out of its resting position in a direction that is opposite to the direction of driving such that said actuating means reaches said second switch generating means and said actuating means switches said second switch generating means to on position whereby said second electric circuit is closed and said third number of braking alert lights are flashed whereby all of said braking alert lights are signaling at the same time;
and
(4) when the braking operation is stopped, the current from the standard car alert system is stopped and all the braking alert lights are extinguished.

The invention will be described herein below in accordance with a preferred embodiment. It will be understood however that the preferred embodiment is not intended to be limiting the invention and that many variations of the invention both as regards design and components and as regards mode of operation may be applied that still remain within the scope of the inventive system and method and as claimed in the claims.

In accordance with the preferred embodiment of the invention, the inventive differential braking alert system lights are installed in the rear window of a vehicle as a continuous array of five lights. The array comprises a slight braking alert light for indicating slight braking together with the standard car braking lights, a pair of increased braking alert lights, one on each side of the slight braking alert light, for indicating increased braking together with the slight braking alert light and the standard car braking alert lights and a pair of emergency braking alert lights, one on each side of the increased braking alert lights, for indicating sudden and forcible braking together with the standard car braking alert lights, the slight braking alert light and the increased braking alert lights. The mechanical and electro mechanical elements of the system are installed in a suitable space in the vehicle that may be in the baggage compartment and they comprise a pole balanced on a pivot in a perpendicular orientation with a weight disposed on its lower end and with an actuating means on its top end and a pair of switch means for operating a pair of electrical circuits that supply current for lighting the braking alert lights according to the intensity of the braking operation. The pole is adapted to oscillate around the pivot in a plane that is parallel to the side walls of the vehicle and stop means are provided to prevent the pole from rotating in a full circle around the pivot.

### BRIEF DESCRIPTION OF THE DRAWINGS

The invention will be further described by the accompanying Figures. These are solely intended to describe in detail some preferred embodiments of the invention, and should not be interpreted to limit its scope.

FIG. IA is a rear view of a vehicle with an array of braking alert lights installed in the rear window

FIG. IB is a schematic drawing of the electro mechanical elements of the preferred embodiment

FIG. 1C is a top view of the switch generating means of the preferred embodiment

FIG. 2 A is a rear view of a vehicle with a single braking alert light flashing in the rear window during slight braking

FIG. 2B is a schematic drawing of the electro mechanical elements of the preferred embodiment during slight braking

FIG. 2C is a top view of the switch generating means of the preferred embodiment during slight braking

FIG. 3A is a rear view of a vehicle with three braking alert lights flashing in the rear window during increased braking

FIG. 3B is a schematic drawing of the electro mechanical elements of the preferred embodiment during increased braking

FIG. 3C is a top view of the switch generating means of the preferred embodiment during increased braking

FIG. 4A is a rear view of a vehicle with all braking alert lights installed in the rear window flashing during emergency braking

FIG. 4B is a schematic drawing of the electro mechanical elements of the preferred embodiment during emergency braking

FIG. 4C is a top view of the switch generating means of the preferred embodiment during emergency braking

FIG. 5A is a rear view of a vehicle with all braking alert lights in the rear window extinguished after emergency braking operation is halted.

FIG. 5B is a schematic drawing of the electro mechanical elements of the preferred embodiment at a first stage after emergency braking operation is halted

FIG. 5C is a top view of the switch generating means of the preferred embodiment at a first stage after emergency braking operation is halted.

FIG. 6 A is a rear view of a vehicle with all braking alert lights in the rear window extinguished at a second stage after emergency braking operation is halted.

FIG. 6B is a schematic drawing of the electro mechanical elements of the preferred embodiment at a second stage after emergency braking operation is halted.

FIG. 6C is a top view of the switch generating means of the preferred embodiment at a second stage after emergency braking operation is halted.

FIG. 7 A is a rear view of a vehicle with all braking alert lights installed in the rear window extinguished at a third stage after emergency braking operation is halted.

FIG. 7B is a schematic drawing of the electro mechanical elements of the preferred embodiment in a resting position at a third stage after emergency braking operation is halted.

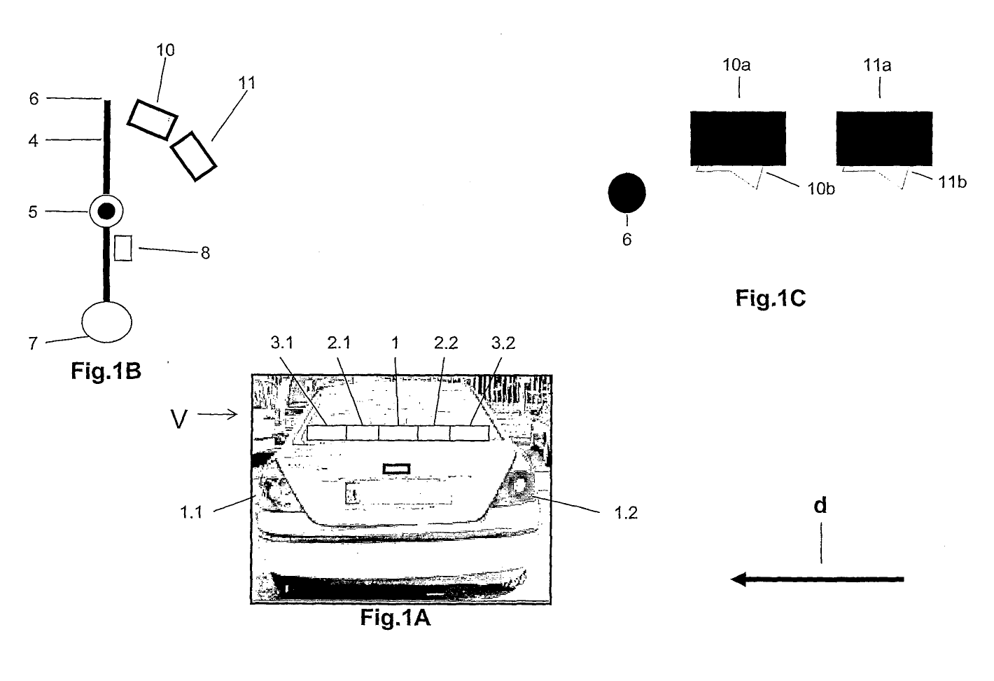

FIG. 1C is a top view of the switch generating means of the preferred embodiment at third stage after emergency braking operation is halted.

FIG. 8A is a rear view of a vehicle with all braking alert lights installed in the rear window extinguished at a fourth stage after emergency braking operation is halted.

FIG. 8B is a schematic drawing of the electro mechanical elements of the preferred embodiment swinging out of the resting position at a fourth stage after emergency braking operation is halted.

FIG. 8C is a top view of the switch generating means of the preferred embodiment at a fourth stage after emergency braking operation is halted.

FIG. 9A is a rear view of a vehicle with all braking alert lights installed in the rear window extinguished at a fifth stage after emergency braking operation is halted.

FIG. 9B is a schematic drawing of the electro mechanical elements of the preferred embodiment in resting position at a fifth stage after the car is halted

FIG. 9C is a top view of the switch generating means of the preferred embodiment at a fifth stage after emergency braking operation is halted.

### DETAILED DESCRIPTION OF THE DRAWINGS

In FIG. IA, the array of braking lights in the preferred embodiment is shown in resting position during steady driving mode or when the car is standing still. The brakes are not operated and none of the vehicle braking lights is on.

As seen in FIG. IA, an array of five lights is installed horizontally in the rear window of the vehicle V. The central light is a slight braking alert light designated 1 that operates simultaneously with the standard car braking alert system. On the rear side of the vehicle

V a pair of standard braking alert lights 1.1 and 1.2 are disposed as known. It will be understood that the slight braking alert light 1 may also be installed in the vehicle as a production standard.

On each side of the slight braking alert light 1 two additional braking alert lights are installed, respectively designated 2.1; 2.2 and 3.1; 3.2. The pair of braking lights nearest to the slight braking alert light, designated 2.1; 2.2 are increased braking alert lights that go on to indicate increased braking whereas the pair of braking alert lights farther away from the slight braking alert light, designated 3.1; 3.2 are emergency braking alert lights that turn on to indicate sudden and forcible emergency braking. An arrow d indicates the driving direction of the vehicle V.

Referring now to FIG. IB, that is a schematic representation of the mechanical and electro mechanical elements of the inventive system, a pole 4 is shown, balanced vertically on a pivot 5 and having an actuating means 6 on its upper end and a weight means 7 on its lower end. It will be understood that the size and mass of the weight means 7 may be varied so as to adapt the inventive system to different vehicles and different vehicle braking systems.

In the embodiment of FIG. IB the actuating means 6 is the end section of the pole 4 without any additional structure. It will be understood however that various kinds of protective covers may be applied to the end section of the pole 4 such as a rubber or metal cover and various kinds of abutments with different shapes and made of different materials may be designed to be comprised in the actuating means 6.

The pole 4 is free to rotate around the pivot 5 such that the actuating means 6 is enabled to move along a semicircular path, not shown in FIG. IB, in a direction that is opposite to the direction of driving. The rotation of the pole 4 and movement of the actuating means 6 in the opposite direction, i.e. in the direction of driving (d) is limited by a stop means 8. It will be understood that the stop means 8 may be replaced by a spring that is connected to the pole at one end and to a suitable point in the vehicle at the other end such that the said spring will limit the movement of the pole away from the resting position and limit the movement of the actuating means away from the direction of driving in the event of a strong braking operation.

As seen best in FIG. 1C, a first electrical switch generating means 10 and a second electrical switch generating means 11, shown in top view, are disposed along the semicircular path of the actuating means 6. The first electrical switch generating means 10 operates a first relay means (not shown) connected in a first electric circuit (not shown). The first electric circuit is supplied from the electric circuit of the standard braking lights. The pair of increased braking alert lights 2.1, 2.2 are connected to said first electric circuit. When the first electrical switch generating means 10 is switched from off position to on position, it operates the relay means to close the first electric circuit whereby current is supplied to the pair of increased braking alert lights 2.1; 2.2. and the increased braking alert lights 2.1; 2.2 are lit.

The second electrical switch generating means 11 operates a relay means (not shown) connected in a second electric circuit (not shown). The second electric circuit is supplied from the electric circuit of the standard braking lights, similarly to the first electric circuit. The pair of emergency braking alert lights 3.1, 3.2 are connected to said second electric circuit. When the second electrical switch generating means 11 is switched from off position to on position, it operates the second relay means to close the second electric circuit whereby current is supplied to the pair of emergency braking alert lights 3.1; 3.2. and the emergency braking alert lights 3.1; 3.2 are lit.

The switch generating means 10; 11 may be designed in accordance with many different shapes and switching methods and they may be assembled from standard elements or designed especially for the inventive system.

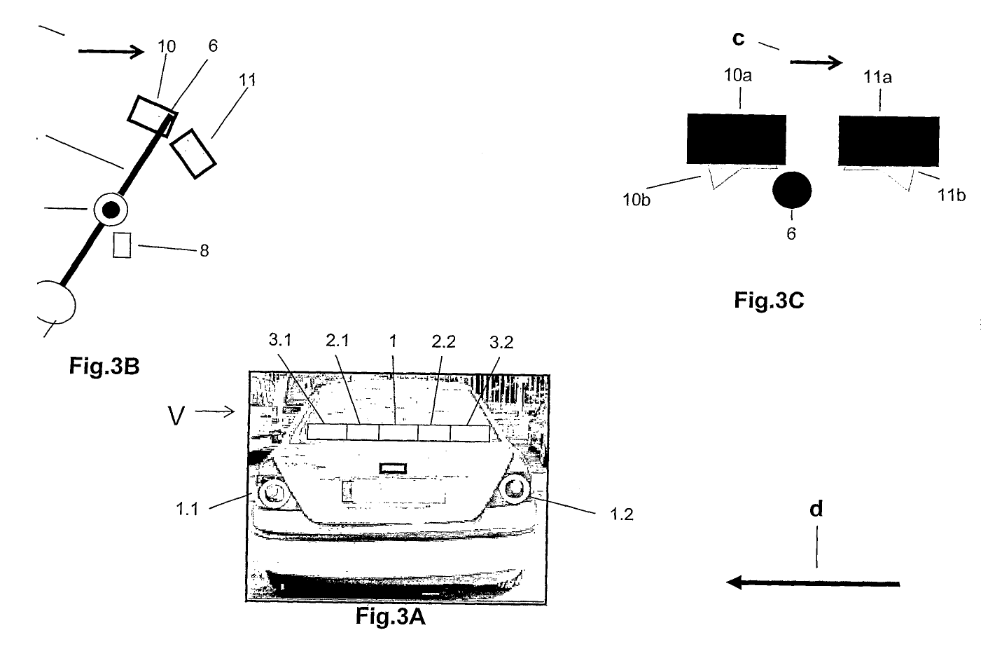

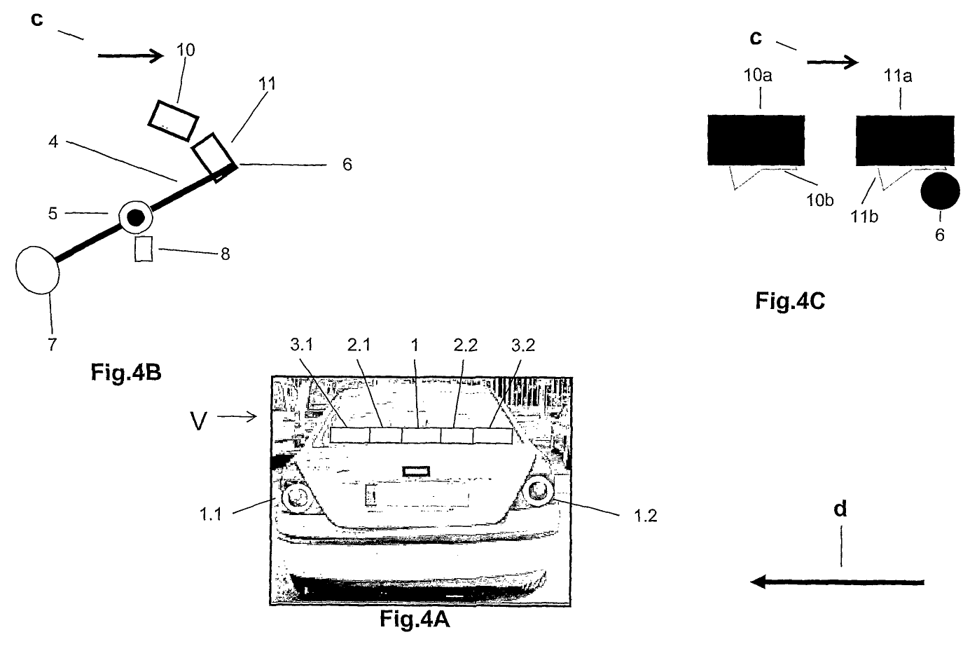

As seen best in FIG. 1C, the switch generating means 10 may be a simple electrical switch with a main body 10a and a switch 10b that has two alternating positions: “off as shown in FIG. 1C and “on”, as shown in FIG. 4C. Similarly, the switch generating means 11 may be a simple electrical switch with a main body 11a and a switch 1 ib that has two alternating positions: “off as shown in FIG. 1C and “on”, as shown in FIG. 3C. It will be understood however that the switch generating means 10 and 11 or only one of them may have a different design and the “on” and “off positions of the switch generating means 10 and 11 may be reversed by simple electronic techniques. In accordance with the preferred embodiment, when the actuating means 4 passes the electrical switch 10 in counter driving direction, it moves the switch 10b from the “off position 1C.2 to the “on” position 1C and when the actuating means 4 passes the electrical switch 10 in driving direction, it moves the switch 10b from the “on” position IC1 to the “off1 position 1C.2. It will be understood that switch 11 is also caused by the actuating means 6 to alternate between the “on” and “off positions shown in FIG. 1C. It will be further understood that when the switch 10b is at the “on” position IC1, the first electric circuit is closed by a relay means as known and when the switch 10b is at the “off position 1C.2, the second electric circuit is opened by the said relay means and the same is true for switch 1 Ib.

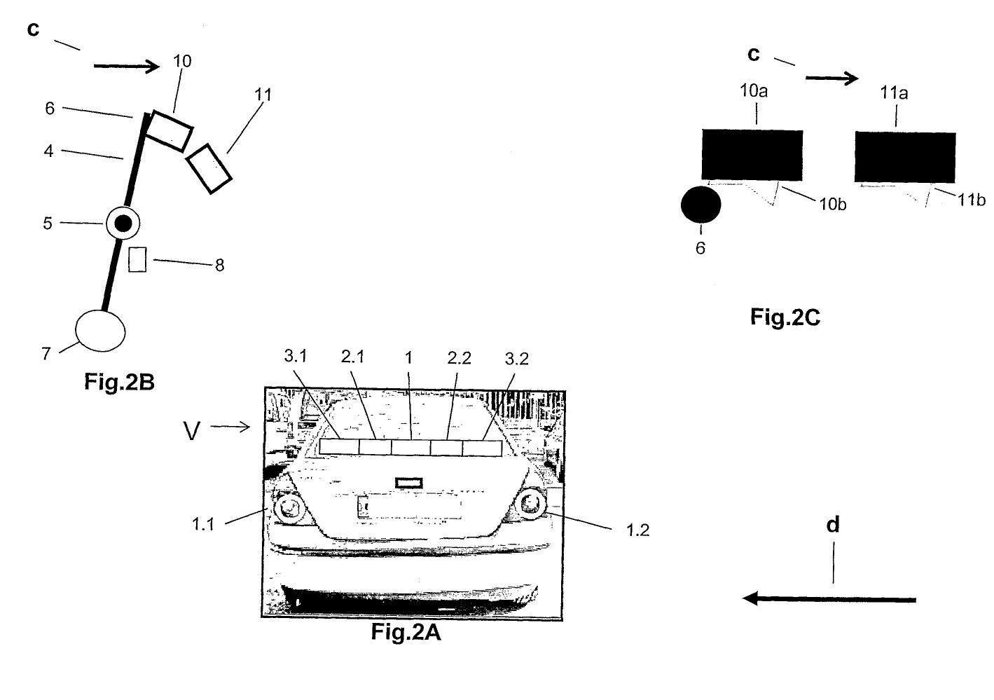

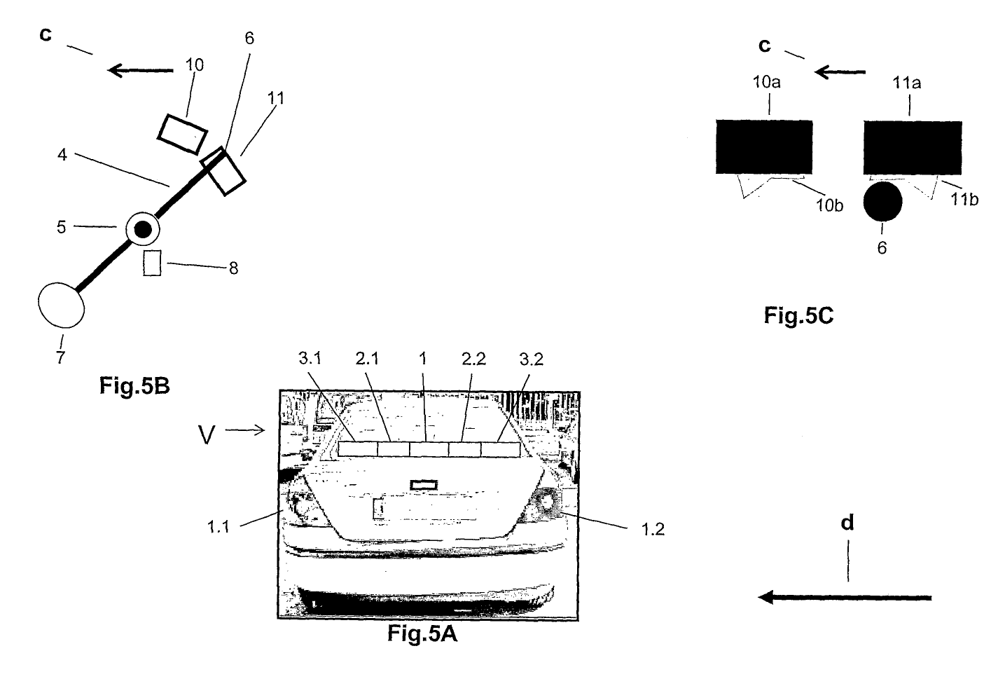

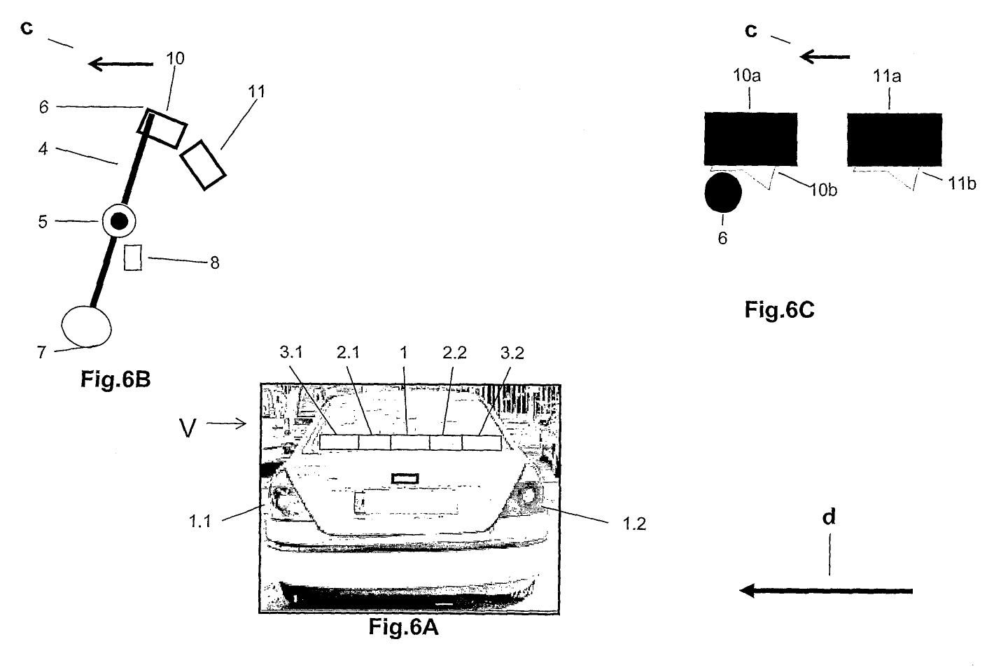

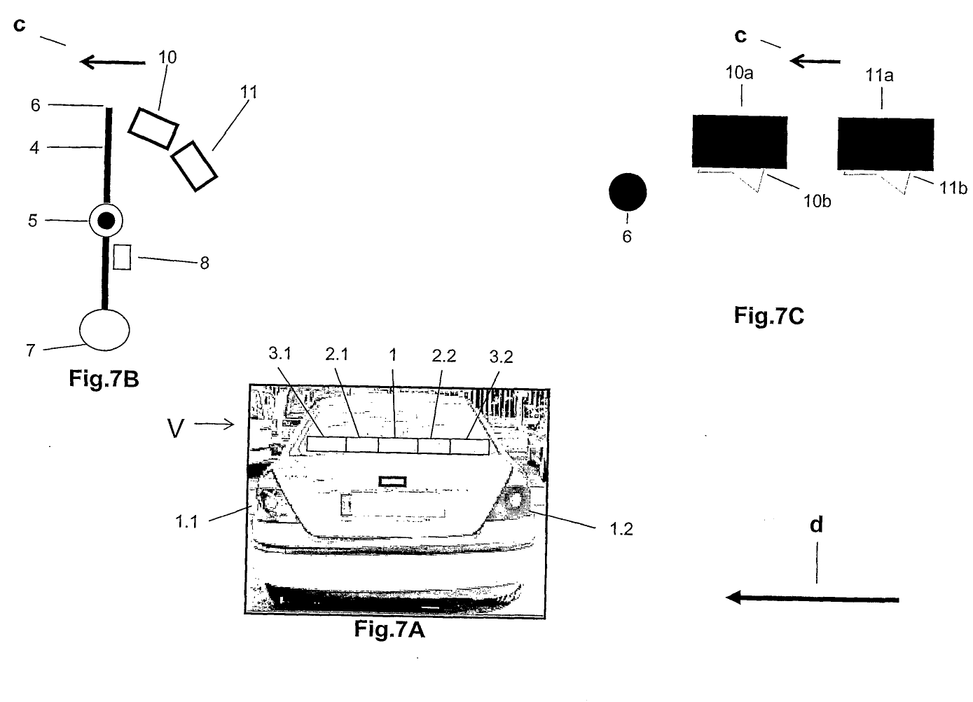

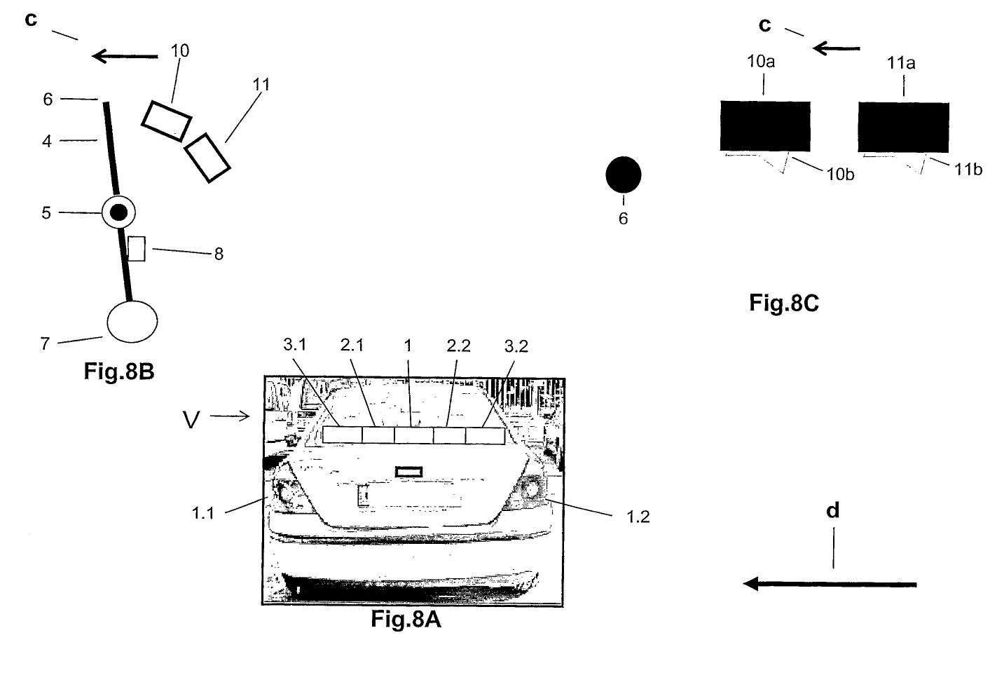

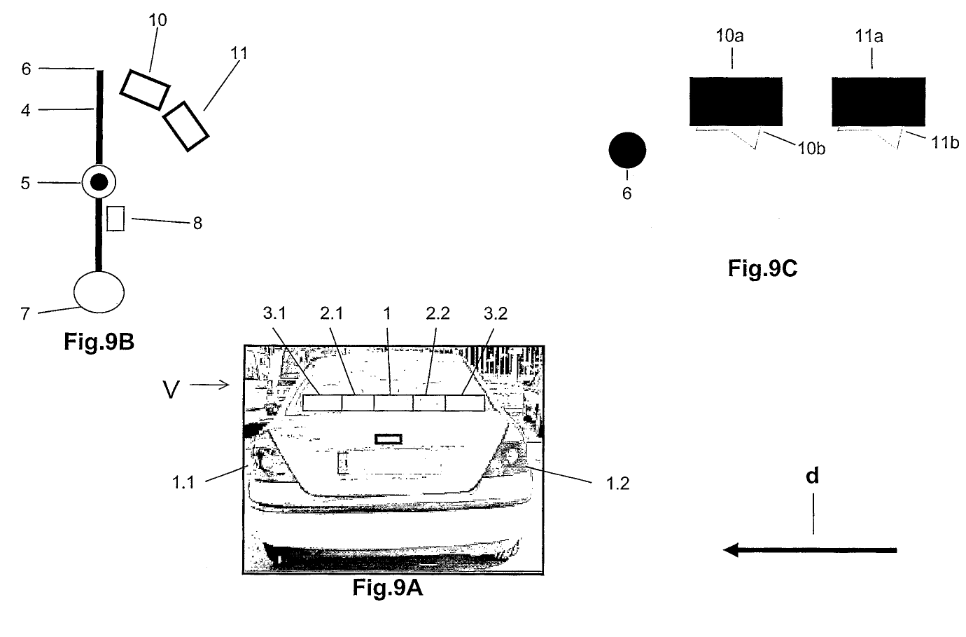

The inventive system alerts a driver of a car driving in the rear to increased braking or sudden and forcible emergency braking by the driver of a car driving in the front as distinguished and differentiated from a slight braking operation by the following process:
a. As seen in FIG. IB, when the vehicle in front is advancing steadily in the direction of driving, the pole 4 remains in a generally vertical position, stabilized by the weight means 7. The actuating means 6 remains in its resting position without contacting either switch generating means 10 or switch generating means 11 and during this phase the car braking lights are all out, including the slight braking alert light 1, the auxiliary normal braking alert lights 2.1; 2.2 and the auxiliary emergency braking alert lights 3.1; 3.2, as shown in FIG. IA. The switches 10b and 1 ib are both in “off position, as seen in FIG. 1C.
b. When the driver of the vehicle in front starts exerting pressure on the brake pedal, the pole 4 is slightly moved from its vertical position due to the movement of the weight means 7 in the direction of driving and the actuating means 6 starts advancing on its semicircular route away from the direction of driving as indicated by the arrow c in FIG. 2B. The actuating means 6 hasn't reached the switch generating means 10; 11 at this stage and the switches 10b and 1 Ib remain in “off” position, as seen in FIG. 2C that is a top view of the switch generating means 10; 11 and the actuating means 6. At this stage the slight braking alert light 1 that receives direct current from the standard braking lights circuit is lit, as seen in FIG. 2A.
c. If the driver releases the brake pedal at this stage, the slight braking alert light 1 goes out together with the standard braking alert lights and the pole 4 returns to its original position.
d. As shown in FIG. 3B, in the event of increased braking the pole 4 moves farther away from its vertical position in a counter driving direction indicated by the arrow c until the actuating means 6 reaches the switch generating means 10. By mechanical pressure the actuating means 6 causes the switch 10b to shift from the “off position shown in FIG. 1C to the “on” position shown in FIG. 3C that is a top view of the switch generating means 10; 11 and the actuating means 6, whereby a relay means (not shown) is activated to close a first electrical circuit that supplies current to the increased braking alert lights 2.1, 2.2 and the increased braking alert lights 2.1, 2.2 go on. As seen in FIG. 3 A, the slight braking alert light is also lit, together with the standard braking alert lights of the vehicle. As a result, a driver in the rear is warned of the event of increased braking in the vehicle driving in front of him by a flashing of three lights in the rear window of the front vehicle.
e. Referring now to FIG. 4B, in the event of forcible and sudden emergency braking the pole 4 passes the switch generating means 10 and moves on in the counter driving direction indicated by the arrow c to a distance that enables the actuating means 6 to reach the switch generating means 11. By mechanical pressure the actuating means 6 causes the switch 1 Ib to shift from the “off position shown in FIG. 1C to the “on” position shown in FIG. 4C that is a top view of the switch generating means 10; 11 and the actuating means 6, whereby a second relay means (not shown) is activated to close a second electrical circuit that supplies current to the increased braking alert lights 3.1, 3.2 and the increased braking alert lights 3.1, 3.2 go on. As seen in FIG. 4A, at this point the slight braking alert and increased braking alert lights of the vehicle are already lit such that a driver in the rear is alerted to the event of emergency braking in the vehicle driving in front of him by a flashing of an array of five lights in the rear window of the front vehicle.
f. When the driver stops braking, current supply to the electrical circuit of the standard car braking alert lights is stopped whereby current to the lights 1, 2.1, 2.2, 3.1, 3.2 of the differential braking alert light array is also stopped and the said braking alert lights 1, 2.1, 2.2, 3.1, 3.2 in said differential braking alert light array go out as seen in FIG. 5A.
g. As shown in FIG. 5B, when the braking action is stopped, the pole 4 starts returning toward its original perpendicular position in the direction of driving as indicated by the arrow c. The actuating means 6 passes the switch generating means 11 in a reverse direction, causing the switch 11b to shift from the “on” position shown in FIG. 4C to the “off” position shown in FIG. 5C that is a top view of the switch generating means 10; 11 and the actuating means 6, whereby the second relay means (not shown) is activated to open the second electrical circuit such that the switch 1 Ib is ready for signaling the next emergency braking operation.
h. Referring now to FIG. 6B, the pole 4 continues its backward movement toward its original perpendicular position in the direction of driving as indicated by the arrow c. The actuating means 6 passes the switch generating means 10b in a reverse direction, causing the switch generating means 10b to shift from the “on” position shown in FIG. 4C to the “off position shown in FIG. 6C whereby the first relay means (not shown) is activated to open the first electrical circuit such that the switch 10b is ready for signaling the next increased braking operation.
i. Referring now to FIG. 7B, the pole 4 reaches its original perpendicular position while moving in the direction of driving as indicated by the arrow c, while the switch generating means 10b, lib remain in “off position as shown in FIG. 7C that is a top view of the switch generating means 10; 11 and the actuating means 6 and the braking alert lights 1, 2.1, 2.2, 3.1, 3.2 of the said differential braking alert light array remain extinguished as seen in FIG. 7A.
j. As seen in FIG. 8B the weight means 7 may move further in the direction of driving as indicated by the arrow c due to well known rules of physics, such that the pole 4 again leaves its original perpendicular position. However the stop means 8 limits this movement of the pole 4 and the pole 4 will finally return to its perpendicular position after some oscillations as seen in FIG. 9B.
   FIGS. 8A and 9A show that during these oscillating movements of the pole 4 the braking alert lights 1, 2.1, 2.2, 3.1, 3.2 of the differential braking alert light array remain extinguished while the switch generating means 10b, lib remain in off position as seen in FIGS. 8C and 9C that are top views of the switch generating means 10; 11 and the actuating means 6.
k. FIG. 9 shows the inventive system in its resting position. As seen in FIG. 9A, the braking alert lights 1, 2.1, 2.2, 3.1, 3.2 of the differential braking alert light array are extinguished. The pole 4 has returned to its perpendicular position and the switch generating means 10b, 1 Ib remain in off position as seen in FIG. 9C. The inventive differential braking alert system is now ready for alerting the rear driver of braking operations of different magnitude performed by the front driver.

In accordance with another preferred embodiment the switch generating means 10 and 11 as well as the actuating means 6 are made of conducting material and the first and second electric circuits are closed by contact between the actuating means 6 and each of the switch generating means 10 and 11 respectively. In this embodiment the switch generating means 10 and 11 are connected to the standard car braking alert light circuit and current is supplied by the said circuit to the switch generating means 10 and 11 in the event of braking.

In this second preferred embodiment the actuating means is 6 designed such that it is enabled to extend from the first switch generating means 10 to the second switch generating means 11 whereby the first switch generating means 10 may be contacted by the actuating means and its respective electric circuit closed such that only the increased braking lights 2.1, 2.2 are lit or both switch generating means 10 and 11 may be contacted at the same time and their respective electrical circuits closed such that both the increased braking alert lights 2.1, 2.2 and the emergency braking alert lights 3.1, 3.2 are lit together with the slight braking alert light 1 and the standard car braking lights 1.1, 1.2.

1. A system for providing different braking alert signals to a driver in a rear car to indicate braking operations of different magnitude by a driver in a front vehicle having the system, comprising:
a. a differential braking light array wherein a first number of braking alert lights is connected to a conventional car braking alert light circuit and is constituting slight breaking alert, a second number of braking alert lights is connected to a first electric circuit and is constituting increased breaking alert and a third number of braking alert lights is connected to a second electric circuit and is constituting emergency breaking alert, both of said first and second electric circuits being fed from the conventional car braking light circuit;
b. a pole having a balanced rest position about a pivot in the vehicle and being pivotable from the balanced rest position in a vertical plane parallel to the driving direction of the vehicle, a weight of or connected to said pole below said pivot is balancing the pole towards the balanced rest position such that an actuating means connected to said pole follows a semicircular course when the pole is pivoting due to deceleration of the vehicle;
c. a stop means to limit the pivoting of said pole away from said balanced rest position when the vehicle is accelerating;
d. a first and a second switch generating means disposed along the semicircular course followed by the actuating means when the pole is pivoting away from said balanced rest position when the vehicle is decelerating, each of the said first and second switch generating means being adapted to operate a respective relay means to close and open the said first and second electric circuits respectively according to a deviation of the pole from the balanced rest position.

2. A system for providing different braking alert signals according to claim 1 wherein the said array of braking alert lights is disposed in the lower frame of a rear window of said vehicle, the said first number of braking alert lights comprises one or more slight braking alert lights, the said second number of braking alert lights consist of two pairs of increased braking alert lights symmetrically disposed at each end of the said first number of braking alert lights and the said third number of braking alert lights consists of two pairs of emergency braking alert lights symmetrically disposed at the outer ends of each of the said pairs of increased braking alert lights.

3. A system for providing different braking alert signals according to claim 1 wherein the said first number of braking alert lights, the said second number braking alert lights and the said third number of braking alert lights are configured to flash in different colours.

4. A system for providing different braking alert signals according to claim 1 wherein the said actuating means and the said switch generating means are made of electrically conductive material.

5. A system for providing different braking alert signals according to claim 1 wherein the said stop means is a mechanical obstacle.

6. A system for providing different braking alert signals according to claim 1 wherein the said stop means is a spring.

7. A system for providing different braking alert signals according to claim 1 wherein said pole, said actuating means, said stop means and said switch generating means are located in the vehicle trunk.

8. A method of providing different braking alert signals to a driver in a rear vehicle to indicate braking operations of different magnitude by a driver in a front vehicle by using a system according to claim 1, wherein:
a. when the brakes are pressed lightly, current from a conventional car braking alert system is fed to said first number of braking alert lights and said first number of braking alert lights are flashed simultaneously with conventional car braking alert lights;
b. when the brakes are pressed with increased pressure said pole deviates out of a balanced rest position such that the actuating means reaches the first switch generating means thereby causing the first switch generating means to operate a respective first relay whereby said first electric circuit is closed and said second number of braking alert lights are flashed;
c. when the brakes are pressed with extremely harsh force said pole deviates out of its balanced rest position such that the actuating means reaches the second switch generating means thereby causing the second switch generating means to operate a respective second relay whereby said second electric circuit is closed and said third number of braking alert lights are flashed whereby all of said braking alert lights are signaling at the same time; and
d. when the braking operation is stopped, the current from the standard car alert system is stopped and all the braking alert lights are extinguished.

9. A method of providing different braking alert signals to a driver in a rear vehicle to indicate braking operations of different magnitude by a driver in a front vehicle according to claim 8, wherein a deviation of the said pole from its balanced rest position is limited by a stop means.

10. A method of providing different braking alert signals to a driver in a rear vehicle to indicate braking operations of different magnitude by a driver in a front vehicle according to claim 8, wherein a deviation of the said pole from its balanced rest position is limited by a spring.

11. A method of providing different braking alert signals to a driver in a rear vehicle to indicate braking operations of different magnitude by a driver in a front vehicle according to claim 8, wherein the said first number of braking alert lights is a single light constituting slight braking alert indicating slight braking operation and is disposed at the center of the said array of braking alert lights.

12. A method of providing different braking alert signals to a driver in a rear vehicle to indicate braking operations of different magnitude by a driver in a front vehicle according to claim 8, wherein the said array of braking alert lights is disposed in the lower frame of a rear window of said vehicle, the said first number of braking alert lights comprises one or more braking alert lights, the said second number of braking alert lights consist of two pairs of braking alert lights symmetrically disposed at each end of the said first number of braking alert lights and the said third number of braking alert lights consists of two pairs of braking alert lights symmetrically disposed at the outer ends of each of the said pairs of the second number of braking alert lights.

13. A method for providing different braking alert signals according to claim 8 wherein the said actuating means and the said first and second switch generating means are made of electrically conductive material, and during an increased braking operation the actuating means reaches the said first switch generating means such that the said first electronic circuit is closed whereby the said second number of braking alert lights are flashed and during an emergency braking operation the actuating means reaches the second switch generating means such that the said second electric circuit is closed whereby the said third number of braking alert lights are flashed.

14. A method for providing different braking alert signals according to claim 8 wherein the said different braking signals are embodied respectively by flashing lights of different colors.
